(19) United States
(12) Patent Application Publication
(10) Pub. No.: US 2016/0110750 A1
(43) Pub. Date: Apr. 21, 2016

(54) REAL-TIME PRICE MANAGEMENT SYSTEM

(71) Applicant: Yuan Ze University, Zhongli City (TW)

(72) Inventors: Guo-Bin JUNG, Zhongli City (TW); Chia-Chen YEH, Miaoli County (TW); Yi-Ju SU, New Taipei City (TW); Chia-Ching MA, Taoyuan City (TW)

(21) Appl. No.: 14/612,611

(22) Filed: Feb. 3, 2015

(30) Foreign Application Priority Data
Oct. 21, 2014 (TW) 103136365

(51) Int. Cl. G06Q 30/02; G06Q 20/20

(52) U.S. Cl. CPC G06Q 30/0223; G06Q 30/0222; G06Q 20/201

(57) ABSTRACT

A real-time price management system is provided which includes a barcode, a computer system, an input device, and a display device. The barcode includes an initial price, a terminal price, a production date, and an expiration date. The computer system forms a price-time equation of merchandise by the barcode, wherein the price-time equation is defined by the initial price, the terminal price, the production date, and the expiration date. The input device scans the barcode and transfers it with a purchase date of the merchandise to the computer system, and then the computer system inputs the purchase date into the price-time equation to obtain a real-time price corresponding to the purchase date. The computer system connects to the display device and shows the real-time price on the display device.

### CROSS-REFERENCE TO RELATED APPLICATION

This application claims priority from Taiwan Patent Application No. 103136365, filed on Oct. 21, 2014, in the Taiwan Intellectual Property Office, the content of which are hereby incorporated by reference in their entirety for all purposes.

### BACKGROUND OF THE INVENTION

1. Field of the Invention

This application relates to a real-time price management system, and more particularly, to a system which is able to automatically adjust merchandise's price according to the purchase date.

2. Description of the Related Art

The traditional merchandise on the market, generally, is of fixed price, but as far as those with expiration date are concerned, such as food, it is unexceptional to be sold with the same price. Therefore, in terms of the consumers, it is the inexorable trend that they want to purchase the merchandise which is dated closer to production date thereof. It proves, the merchandise which is far away production date thereof can't have the consumers' favor, and once the expiration date of the merchandise is exceeded, the store can only destroy it, and as a result, it not only leads to waste, but also increases the cost burden towards the store.

In order to resolve the problem, the merchandise which is about to expire is usually placed in front of showcase, or by means of promotion such as short-term preferential price, discount or with free gift and so on to attract consumers' purchase desire. These methods, however, are negative and have little reaction, and additionally, application of human resource may limit its effectiveness.

In addition, as far as the non-edible goods are concerned, such as 3C products, time plays a critical role in the price fluctuation towards the products. Generally, store often re-prices those products by labor power, but it may cause errors in the price. In addition, the real-time determination can't be made based on the launch date of the product, resulting that the store is incapable of determining the price of current merchandise accurately.

### SUMMARY OF THE INVENTION

In order to effectively resolve the preceding technical problems, the present invention is to provide a real-time price management system which may include a barcode, a computer system, an input device and a display device. The barcode includes an initial price, a terminal price, a production data and an expiration date of merchandise, wherein the expiration date is behind the production date. The computer system forms a price-time equation of merchandise by the barcode, wherein the price-time equation is defined by the initial price, the terminal price, the production date, a purchase date and the expiration date. The input device electrically connected to the computer system for scanning the barcode and transferring the purchase date of the merchandise to the computer system, then the computer system inputs the purchase date into the price-time equation to obtain a real-time price corresponding to the purchase date. The display device electrically connected to the computer system and the real-time price is displayed on the display device.

Preferably, the price-time equation may be a linear equation:

$$P = Pi - \frac{Pi - Pn}{Tn - Ti} \times ( T - Ti )$$

wherein, P may be the real-time price, T may be the purchase date, Pᵢ may be the initial price, Pₙ may be the terminal price, Tᵢ may be the production date and Tₙ may be the expiration date.

Preferably, the computer system may further include a first logical device configured to determine whether the real-time price is lower than the terminal price.

Preferably, when the real-time price is determined lower than the terminal price, the computer system may replace the real-time price with the terminal price.

Preferably, the computer system may further include a second logical device configured to determine whether the purchase date exceeds the expiration date.

Preferably, the real-time price management system of the present invention may further include a warning device electrically connected to the second logical device of the computer system, and when the purchase date is determined exceeding the expiration date, the warning device may send an expiration warning which may be displayed on the display device.

Preferably, the computer system may further include a memory device configured to store the price-time equation.

Preferably, the computer system may be a connectible computer terminal, and electrically connected to a memory device of another computer system to perform real-time information synchronous management.

Preferably, the price-time equation may be an equation of degree N, and wherein N may be a natural number.

According to the aforementioned description, besides the preceding advantages, the present invention may be able to enable store obtaining real-time price of merchandise by means of a computer system reading barcode, the consumer may also realize the real-time price of the merchandise precisely so as to become an effective media among store, merchandise and consumer.

### BRIEF DESCRIPTION OF THE DRAWINGS

FIG. 1 is a block diagram of a real-time price management system in accordance with an exemplary embodiment of the present invention.

FIG. 2 is a curve diagram of a price-time equation in accordance with an exemplary embodiment of the present invention.

FIG. 3 is a polynomial curve diagram of a price-time equation in accordance with an exemplary embodiment of the present invention.

FIG. 4 is a polynomial curve diagram of a price-time equation in accordance with another exemplary embodiment of the present invention.

### DETAILED DESCRIPTION OF THE PREFERRED EMBODIMENTS

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

For the sake of resolving the preceding technical problems, purpose of the present invention is to provide a real-time price management system which is capable of automatically correct the real-time price of merchandise by means of a barcode that is characterized of diverse information such as consumer's purchase time, merchandise's production date, expiration date (or preserved date), producer, place of production and country of manufacturer.

The drawings and description are to be regarded as illustrative in nature and not restrictive. Similar reference numerals designate similar elements throughout the specification.

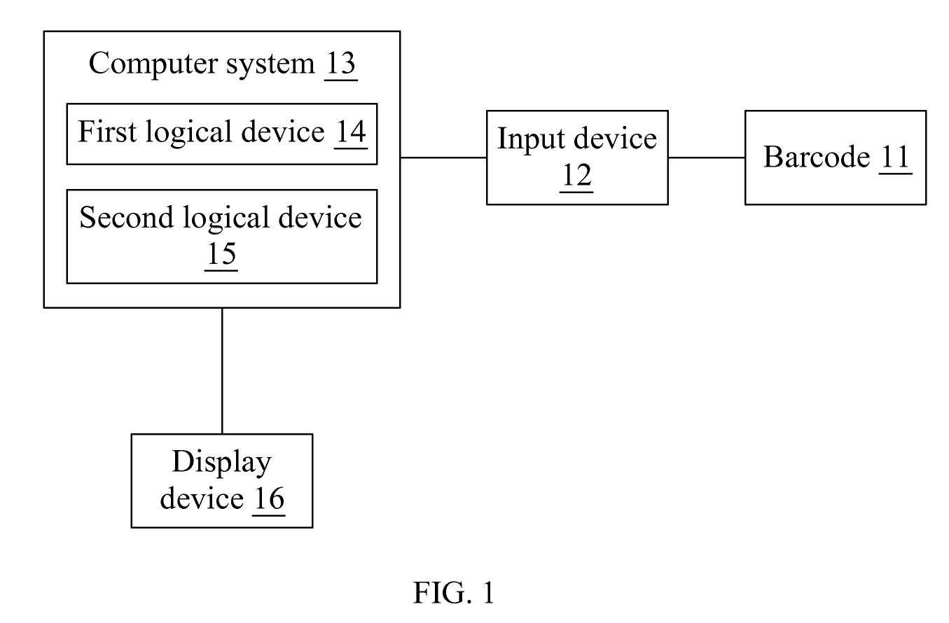

Please refer to FIG. 1 which is a block diagram of a real-time price management system in accordance with an exemplary embodiment of the present invention. A real-time price management system of the present invention may mainly include a barcode 11, an input device 12, a computer system 13 and a display device 16.

In accordance with an exemplary embodiment of the present invention, the barcode 11 may be construed to be any graphical image capable of representing a sequence of characters (including numbers, letters, or other symbols) in accordance with a particular encoding or decoding standard, such as a Quick Response (QR) Code. The barcode 11 may be affixed on the packaging of the merchandise or be printed on the merchandise. The barcode 11 may at least include an initial price, a terminal price, a production date and an expiration date of merchandise, but not limited to. Besides, it may further include information such as manufacturer of the merchandise and place of production and so on. Wherein, the initial price is meant to the first price of the merchandise at the production date, the terminal price is meant to the expected final price when the merchandise is not sold anymore, the production date is meant to the completion date of the merchandise, and the expiration date is meant to the expected ending date of the merchandise. Additionally, the expiration date may be behind the production date. Moreover, according to the exemplary embodiment of the present invention, the merchandise's price decreases gradually with time, and thus, the terminal price may be lower than the initial price, but not limited to. The merchandise's price may increase with time, that is, the terminal price may be higher than the initial price.

In accordance with an exemplary embodiment of the present invention, the input device 12 may be a barcode scanner. The computer system 13 may be a conventional server or personal computer, including a central processing unit (CPU), a system memory, including a random access memory (RAM) and a read-only memory (ROM), and a system bus that couples the memory to the CPU. A basic input/output system (BIOS) containing the basic routines that help to transfer information between elements within the computer, such as during startup, is stored in the ROM. As discussed above, the BIOS may include a setup program that includes functionality for specifying the boot order of mass storage devices connected to the computer. The computer system 13 may be a connectible computer terminal which may be electrically connected to another computer system to perform real-time information synchronous management. Preferably, the computer system 13 may include memory device configured to store the merchandise information contained in the barcode 11, or to store the price-time equation which will be explained as follows. The memory device may include different types of mass storage devices, such as a removable media device, a hard disk drive device (also referred to as a fixed disk device), or an optical drive device. However, the exemplary embodiment of the present invention shall not be subject to this restriction. For example, the input device 12, the computer system 13 and the display device 16 may be included within a smartphone having camera capability together, or within a device which enables to scan, read the real-time price barcode and to display the merchandise information. The display device 16 may be a cathode ray tube (CRT), a liquid crystal display (LCD), an organic light emitting diode (OLED), or a plasma display.

Therefore, in accordance with an exemplary embodiment of the present invention, the input device 12 may scan the barcode 11 and to transfer the initial price, terminal price, production date and expiration date contained in the barcode 11 to the computer system 13 through the input device 12 which is electrically connected to the computer system 13. In addition, the input device 12 may simultaneously record the purchase date of the merchandise in the computer system. It is noteworthy that the purchase date mentioned in the present invention may not certainly the date buying the merchandise. The purchase date of the present invention only indicates the date contained in the barcode 11 which is scanned by the input device 12 and transferred to the computer system 13. Therefore, the purchase date may indicate the date of merchandise information contained in the barcode 11 which is received by the computer system 13.

Afterwards, the computer system 13 specifies the purchase date into the price-time equation to obtain a real-time price corresponding to the purchase date. Wherein, the price-time equation may be a price-time mathematical equation which is defined by the merchandise information contained in the barcode 11. The merchandise information may include the initial price, terminal price, production date and expiration date of the merchandise. In accordance with an exemplary embodiment of the present invention, the price-time equation is used to enable the computer system 13 performing real-time calculation towards the real-time price corresponding to the purchase date. In addition, when the computer system 13 calculates the real-time price corresponding to the purchase date, the display device 16 which is electrically connected to the computer system is configured to display the real-time price. According to this, this transformation may lead to the different way of displaying the price of the merchandise. New price tags do not need to be printed and labeled on the merchandise. The customer can easily obtain the correct and real-time price.

In accordance with an exemplary embodiment of the present invention, the obtained real-time price may be smaller or equal to the initial price, and may be higher or equal to the terminal price. For example, when the purchase date is equal to the production date, the real-time price is equal to the initial price. Besides, when the purchase date is equal to the expiration date, the real-time price is equal to the terminal price.

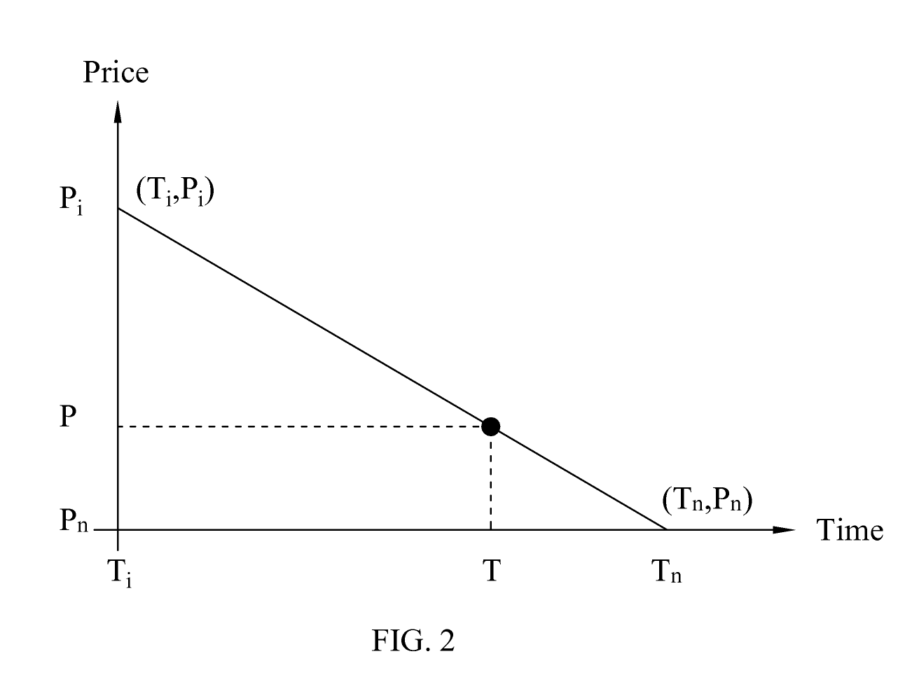

Please refer to FIG. 2 which is a curve diagram of a price-time equation in accordance with an exemplary embodiment of the present invention. Wherein, an exemplary embodiment of the price-time equation shown in FIG. 2 can be seen as the following equation (1):

$$P = Pi - \frac{Pi - Pn}{Tn - Ti} \times ( T - Ti ) . \qquad equation ( 1 )$$

Wherein, P may be the real-time price, T may be the purchase date, Pᵢ may be the initial price, Pₙ may be the terminal price, Tᵢ may be the production date and Tₙ may be the expiration date.

It can be found through the preceding explanation that the merchandise information contained in the barcode 11 may have included the initial price Pᵢ, the terminal price Pₙ, the production date Tᵢ and the expiration date Tₙ. The purchase date T may be recorded in the computer system 13 when the input device 12 is transferring the merchandise information. Therefore, as FIG. 2 and the equation (1) show that the initial price Pᵢ, the terminal price Pₙ, the production date Tᵢ and the expiration date Tₙ are all known, and the real-time price P corresponding to the purchase date T may be obtained by specifying the preceding numerical.

In addition, in accordance with an exemplary embodiment of the present invention, the price-time equation may be an equation of degree N, and wherein N may be a natural number. For example, N=2,

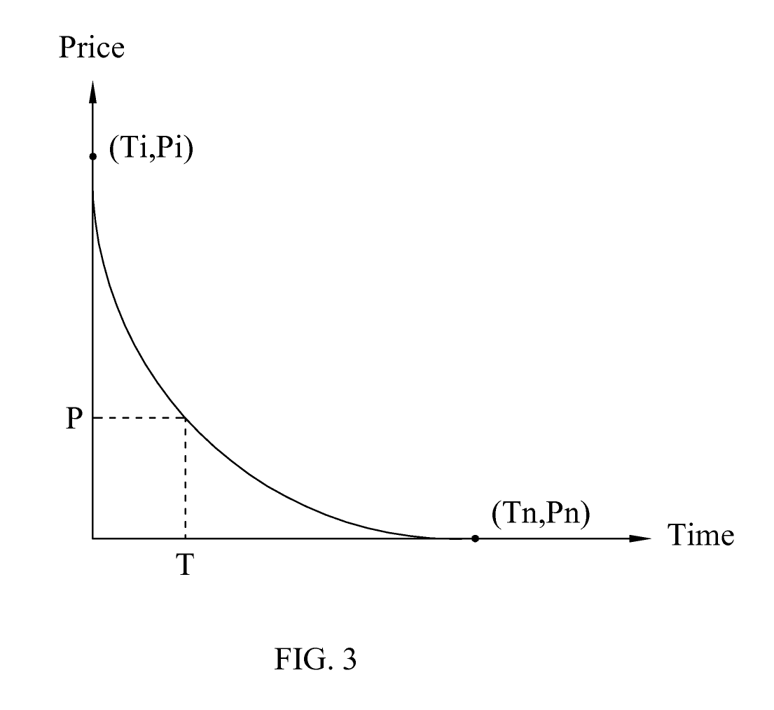

Please refer to FIG. 3 which is a polynomial curve diagram of a price-time equation in accordance with an exemplary embodiment of the present invention. Wherein, an exemplary embodiment of the price-time equation shown in FIG. 3 can be seen as the following equations (2) and (3).

$$\begin{matrix}P = {a ( T - Tn )}^{2} + Pn ; & equation ( 2 ) \\ a = \frac{Pi - Pn}{{( Ti - Tn )}^{2}} . & equation ( 3 )\end{matrix}$$

Wherein, P may be the real-time price, α may be the variable of the curve, T may be the purchase date, Pᵢ may be the initial price, Pₙ may be the terminal price, Tᵢ may be the production date and Tₙ may be the expiration date.

Consequently, the merchandise information contained in the barcode 11 may have included the initial price Pᵢ, the terminal price Pₙ, the production date Tᵢ and the expiration date Tₙ. The purchase date T may be recorded in the computer system 13 when the input device 12 is transferring the merchandise information. Therefore, as FIG. 3 and the equations (2) and (3) show that by means of specifying the initial price Pᵢ, the terminal price Pₙ, the production date Tᵢ and the expiration date Tₙ to equation (3) may obtain numerical α, and then the variable α, the terminal price Pₙ, the expiration date Tₙ and the purchase date T which are all known may be specified to equation (2) to hence obtain the real-time price P corresponding to the purchase date T.

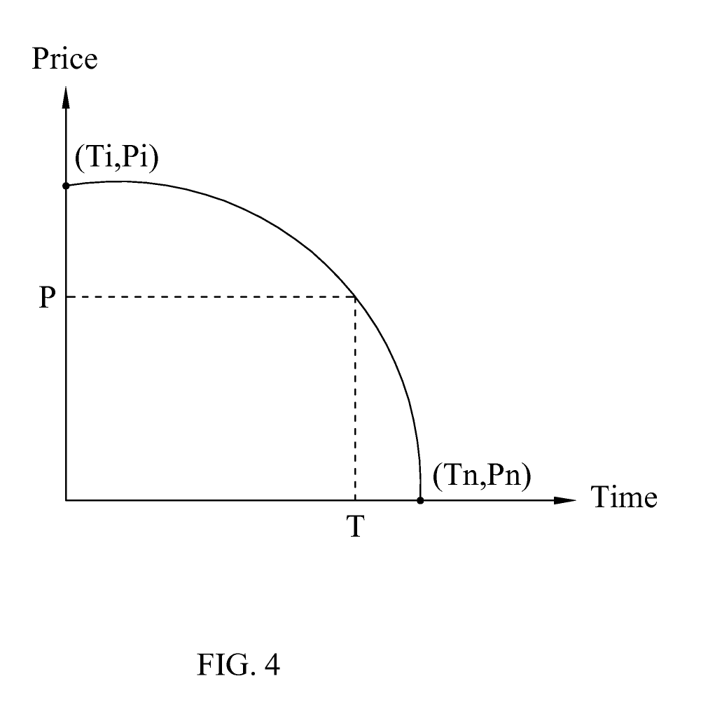

Please refer to FIG. 4 which is a polynomial curve diagram of a price-time equation in accordance with another exemplary embodiment of the present invention. Wherein, another exemplary embodiment of the price-time equation shown in FIG. 4 can be seen as the following equations (4) and (5).

$$\begin{matrix}P = {a ( T - Ti )}^{2} + Pi ; & equation ( 4 ) \\ a = \frac{Pn - Pi}{{( Tn - Ti )}^{2}} . & equation ( 5 )\end{matrix}$$

Wherein, P may be the real-time price, α may be the variable of the curve, T may be the purchase date, Pᵢ may be the initial price, Pₙ may be the terminal price, Tᵢ may be the production date and Tₙ may be the expiration date.

As a result, the merchandise information contained in the barcode 11 may have included the initial price Pᵢ, the terminal price Pₙ, the production date Tᵢ and the expiration date Tₙ. The purchase date T may be recorded in the computer system 13 when the input device 12 is transferring the merchandise information. Therefore, as FIG. 4 and the equations (4) and (5) show that by means of specifying the initial price Pᵢ, the terminal price Pₙ, the production date Tᵢ and the expiration date Tₙ to equation (5) may obtain numerical α, and then the variable α, the terminal price Pₙ, the production date Tᵢ and the purchase date T which are all known may be specified to equation (4) to hence obtain the real-time price P corresponding to the purchase date T

Please refer to FIG. 1 once again. The computer system 13 may further include a first logical device 14 configured to determine whether the real-time price P is lower than the terminal price Pₙ. When the real-time price P is determined lower than the terminal price Pₙ, computer system may replace the numerical of the real-time price P with the numerical of the terminal price Pₙ. Therefore, in accordance with an exemplary embodiment of the present invention, when the real-time price P is determined lower than terminal price Pₙ, the real-time price P shown in the display device 16 is equal to the terminal price Pₙ.

As shown in FIG. 1, the computer system 13 may further include a second logical device 15 configured to determine whether the purchase date T exceeds the expiration date Tₙ. In addition, a real-time price management system of the present invention may further include a warning device electrically connected to the second logical device 15 of the computer system 13, and when the purchase date T is determined exceeding the expiration date Tₙ, the warning device may send an expiration warning which may be displayed on the display device 16 to remind consumer of the information pertaining to the expiration date of the merchandise.

According to the preceding descriptions, a real-time price management system provided by the present invention is able to automatically correct the real-time price corresponding to production date, expiration date or purchase date of merchandise, and then to display the information to consumer for reference. Consequently, it not only enables the consumer choosing merchandise which matches the practical need according to one's economic power (e.g. it may cost higher provided that the merchandise which is closer to production date thereof is desired), but also helps store to save personnel cost so as to boost the industrial (productive) applicability and to be an effect media between the product and the consumer.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A real-time price management system, comprising:
a barcode comprising an initial price, a terminal price, a production date and an expiration date of merchandise, wherein the expiration date is behind the production date;
a computer system forming a price-time equation of the merchandise by the barcode, wherein the price-time equation is defined by the initial price, the terminal price, the production date, a purchase date and the expiration date;
an input device electrically connected to the computer system for scanning the barcode and transferring the purchase date of the merchandise to the computer system, and
a display device electrically connected to the computer system;
wherein the computer system inputs the purchase date into the price-time equation to obtain a real-time price corresponding to the purchase date, and the real-time price is displayed on the display device.

2. The real-time price management system of claim 1, wherein the price-time equation is a linear equation:
$$P = Pi - \frac{Pi - Pn}{Tn - Ti} \times ( T - Ti )$$
wherein, P is the real-time price, T is the purchase date, Pᵢ is the initial price, Pₙ is the terminal price, Tᵢ is the production date and Tₙ is the expiration date.

3. The real-time price management system of claim 2, wherein the computer system further comprises a first logical device configured to determine whether the real-time price is lower than the terminal price.

4. The real-time price management system of claim 3, wherein when the real-time price is determined lower than the terminal price, the computer system replaces the real-time price with the terminal price.

5. The real-time price management system of claim 1, wherein the computer system further comprises a second logical device configured to determine whether the purchase date exceeds the expiration date.

6. The real-time price management system of claim 5, further comprising a warning device electrically connected to the second logical device of the computer system, and when the purchase date is determined exceeding the expiration date, the warning device sends an expiration warning which is displayed on the display device.

7. The real-time price management system of claim 1, wherein the computer system further comprises a memory device configured to store the price-time equation.

8. The real-time price management system of claim 7, wherein the computer system is a connectible computer terminal, and electrically connected to a memory device of another computer system to perform real-time information synchronous management.

9. The real-time price management system of claim 1, wherein the price-time equation is an equation of degree N, and wherein N is a natural number.
